(19) United States
(12) Patent Application Publication
(10) Pub. No.: US 2009/0164314 A1
(43) Pub. Date: Jun. 25, 2009

(54) MERCHANT SPECIFIED USAGE SCHEME IN FINANCIAL TRANSACTIONS

(75) Inventor: Simon Blythe, Cambridgeshire (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/963,277

(22) Filed: Dec. 21, 2007

(51) Int. Cl. G06Q 30/00

(52) U.S. Cl. 705/14

(57) ABSTRACT

The preferred embodiments of the present invention are directed to enabling a merchant to specify whether other entities or employees thereof should benefit from a usage scheme, such as discounts, incentives, promotions, rewards, or the like, implemented by the merchant. A transaction device holds information associating the transaction device with an entity. The information associating the transaction device with the entity is verified against stored merchant identification code to determine whether the holder of the transaction device should receive the benefit of the usage scheme.

### BACKGROUND

In recent years, non-cash transactions have become a preferred method of payment for consumers. Such transactions typically use transaction devices, such as credit cards or debit cards. Credit cards allow consumers to engage in financial transactions with a participating merchant without a present requirement of money from the consumer. In a typical credit card transaction, the participating merchant receives payment from a financial institution that has agreed to allow the consumer to make purchases on credit with the promise to pay the financial institution the purchase amount plus some calculated interest at a later time. Debit cards function in a similar manner as credit cards, but instead of drawing on credit, the consumer draws against money deposited with a financial institution, usually a financial institution with which the consumer has a bank account.

Financial institutions providing these accounts have provided usage schemes, such as incentives, promotions, and/or rewards to account holders for using their accounts in financial transactions. Such usage schemes directed to account holders have been an effective method for generating account usage for financial institutions. However, these usage schemes do not provide merchants-to-merchant discounts, incentives, promotions, and/or rewards.

A system and method for enabling one merchant to provide another merchant or employees thereof the benefits of a usage scheme implemented by the merchant is desired.

### SUMMARY

The preferred embodiments of the present invention are directed to enabling a merchant to specify whether other entities or employees thereof should benefit from a usage scheme. Such a usage scheme can include, but is not limited to discounts, incentives, promotions, rewards, or the like. The merchant can specify merchant discount information for entities that the merchant wishes to receive the benefit of the usage scheme. A transaction device holds an identifier associating the transaction device with an entity. During a financial transaction, the identifier associating the transaction device with the entity is verified against stored merchant identification code to determine whether the holder of the transaction device should receive the benefit of the usage scheme.

In one embodiment, a method of implementing a merchant specified usage scheme is disclosed. The method includes obtaining an identifier from a transaction device associating the transaction device with an entity and verifying the identifier against a merchant identification code. The method also includes determining whether a holder of the transaction device receives a benefit of the merchant specified usage scheme based on the verification.

In another embodiment, a computer readable medium that holds instructions executable by a computing device to implement a merchant specified usage scheme is disclosed. The instruction implement the merchant specified by verifying an identifier associating a transaction device with an entity against a stored merchant identification code and determining whether a holder of the transaction device receives a benefit of the merchant specified usage scheme based on the verification.

In yet another embodiment, a system for implementing a merchant specified usage scheme is disclosed. The system includes one or more computing devices configured to obtain an identifier from a transaction device associating the transaction device with an entity, verify the identifier against a stored merchant identification code and determine whether a holder of the transaction device receives a benefit of the merchant specified usage scheme based on the verification.

In still another embodiment, a transaction device for facilitating a merchant specified usage scheme is disclosed. The transaction device includes a storage medium that holds an identifier associating the transaction device with an entity. The identifier is readable by a merchant terminal to determine whether a holder of the transaction device receives a benefit of the merchant specified usage scheme.

The preferred embodiments of the present invention, as well as other objects, features and advantages of the present invention will be apparent from the following detailed description, which is to be read in conjunction with the accompanying drawings. The scope of the invention will be pointed out in the claims.

### BRIEF DESCRIPTION OF THE DRAWINGS

FIG. 1 depicts an exemplary financial transaction system in accordance with preferred embodiments of the present invention;

FIG. 2 is a flow chart for implementing a usage scheme in accordance with the preferred embodiments of the present invention; and

FIG. 3 depicts a financial institution terminal for implementing the preferred embodiments of the present invention.

### DETAILED DESCRIPTION OF PREFERRED EMBODIMENTS

The preferred embodiments of the present invention are directed to providing usage schemes for financial transactions based on an association between the purchaser and a selected entity. Such usage schemes can include, but are not limited to discounts, incentives, rewards, promotions, and the like. The preferred embodiments allow, for example, one merchant to give discounts to another merchant or to employees thereof In accordance with the preferred embodiments, a merchant can specify which merchants or employees thereof should receive a discount on goods or services.

The preferred embodiments provide merchants with the ability to form relationships with other merchants based on usage schemes and allow merchants implementing the usage scheme to increase financial transactions entered into by enticing other merchants or employees thereof to take advantage of the usage scheme. Using a transaction device that holds an identifier associating the transaction device with an entity provides a controlled approach to ensure only those who are selected receive the benefit of the usage scheme. As a result, the preferred embodiments provide an efficient automated approach for determining when the usage scheme applies since the transaction device and the identifier can be implemented in a single device.

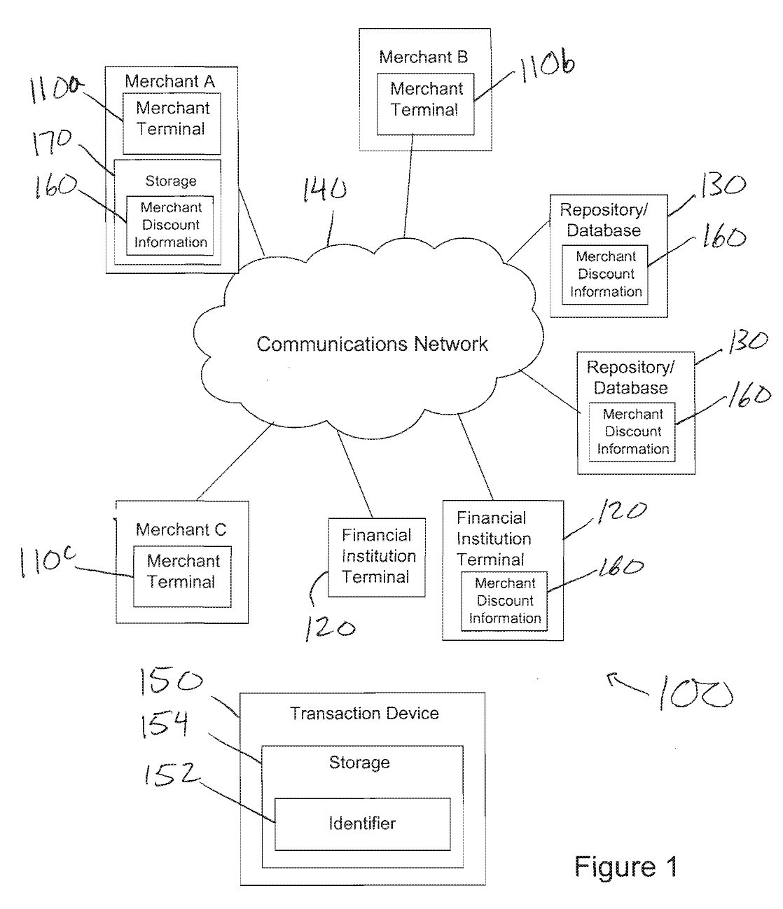

FIG. 1 depicts a financial transaction system 100 that preferably includes distinct merchants A-C having merchant terminals 110a-c, respectively. The system also preferably includes one or more financial institution terminals 120, one or more databases/repositories 130, and communication network 140, such as a public switched telephone network (PSTN), virtual private network (VPN), Internet, or the like. The merchant terminals 110a-c can represent devices that read account information from a customer's transaction device 150. Merchants A-C that use the merchant terminals 110a-c, respectively, may, for example, sell goods or services. The merchant terminals 110a-c can be dispersed throughout the world according to the geographic location(s) of the merchants A-C and the merchants A-C may each have multiple locations and merchant terminals.

The customer transaction device 150 can be, but is not limited to a credit card, debit card, smart card, cellular phone or other suitable computing devices and preferably includes an identifier 152 associating the transaction device 150 with a merchant. For example, the customer can be an employee of merchant B and the identifier 152 included with the transaction device 150 can associate the transaction device 150 with the merchant B. The transaction device 150 preferably includes storage 154, preferably implemented as a smart card or the like, that is capable of storing and allowing access to the identifier 152. Alternatively, the identifier 152 can be embedded in a magnetic strip of, for example, a credit card or debit card.

The identifier can be a string of characters, such as alphanumeric characters of varying lengths, a binary sequence, a Boolean sequence, a sequence of magnetic polarizations, or the like. For example, the identifier can be a string of eight characters, such as “merchant,” used to identify a particular merchant. The identifier may be encrypted and/or encoded using techniques known to those skilled in the art. When the identifier 152 is verified against a merchant identification code included in the merchant discount information 160, the application performing the verification can have a mapping between the identifier 152 and the merchant discount information so that the identifier can be authenticated. In some embodiments, the identifier and the merchant identification code can be identical such that the application performing the verification can perform a simple comparison between the elements of the identifier 152 and the elements of the merchant identification code. In other embodiments, a complex scheme can be implemented. For example, a merchant (e.g., merchant A) can use codes related to goods or services being purchased so that the merchant can selectively apply usage schemes based on goods or services being purchased, or the merchant can place a limit on the availability of the usage scheme based on goods or services being purchased, such as restricting the number of items for which the purchaser (e.g., merchant B or employees thereof) receives a discount.

The one or more financial terminals 120 can receive, collect, and maintain information in storage included in the financial terminals 120 and/or in the databases 130. The information can include merchant discount information 160 specified by, for example, merchant A that determines whether merchants B and/or C and employees thereof should receive the benefit of merchant A's usage scheme on purchases made at merchant A. The merchant discount information 160 can include, for example, a merchant identification code that identifies merchants or employees thereof that are eligible to receive discounts from merchant A.

The merchant identification code can include a sequence of character and may include a merchant name. The merchant identification code can be associated with the identifier 152 included with customer transaction device 150. The one or more financial terminals 120 can also receive, collect, and maintain information including, but not limited to an account number, a credit limit, an amount of money due, an address of the account holder, transaction information for purchase made by the account holder. The financial institution can use this information when determining whether to authorize payment for the goods or services that a customer wishes to purchase.

Alternatively, the merchants A-C can maintain the merchant discount information 160 without involvement from the financial terminals 120. For example, the merchants A-C can have a storage device 170 in which the merchant discount information 160 is stored or can have databases 130 separate from those associated with the financial institutions.

In a financial transaction, a customer associated with merchant B (e.g., an employee) wishes to purchase an item from merchant A. Merchant A obtains information, including the identifier 152 associating the transaction device 150 with merchant B, from the transaction device 150 using the merchant terminal 110a. The merchant terminal 110a determines whether the holder of the transaction device 150 should receive a discount based on the identifier.

The financial terminal 120 collects transaction information associated with the purchase and stores the information either locally or remotely. The transaction information can include a purchase date and time, a purchase amount, a merchant name, merchant category, and a merchant location (including street number, address, city, state, country, or the like). The one or more financial terminals can be implemented in a central or distributed manner such that the transaction information and other account information can be in different locations.

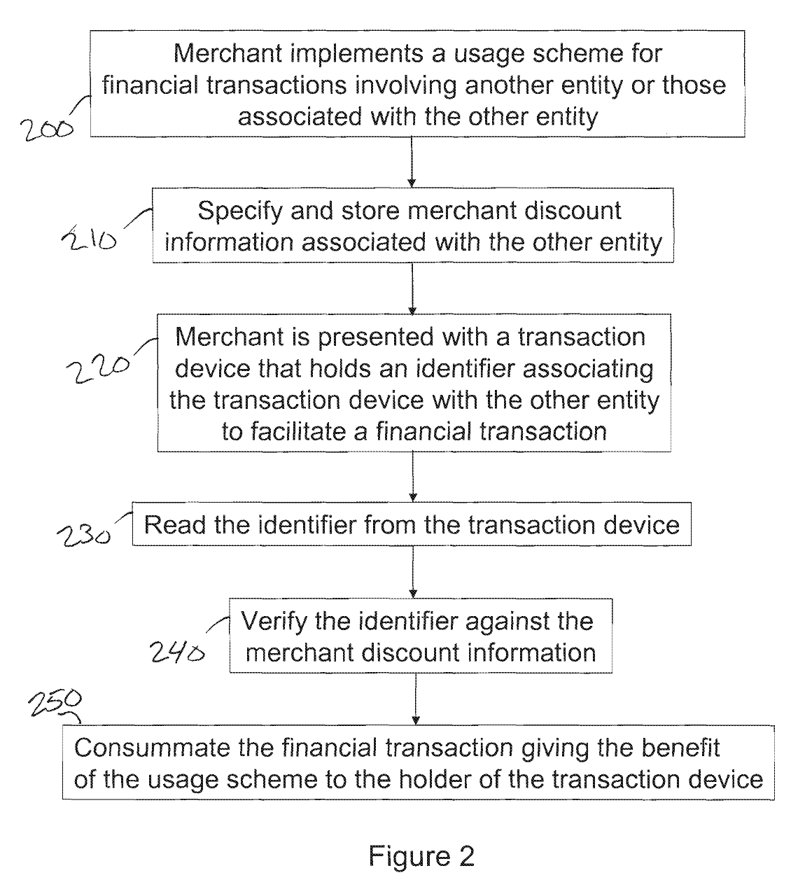

FIG. 2 is a flowchart illustrating a merchant based usage scheme in accordance with a preferred embodiment of the present invention. Merchant A may wish to implement a usage scheme for financial transactions involving another entity, such as merchant B or employees thereof (step 200). For example, merchant A can give employees of merchant B discounts. Merchant discount information 160 associated with merchant B can be specified by merchant A and can be stored in one or more merchant terminals 110, databases 130, and/or financial terminals 120 to allow merchant B or employees thereof to benefit from a usage scheme offered by merchant A (step 210).

When the merchant B or employees thereof desire to purchase goods or services from merchant A using the transaction device 150, the holder of the transaction device 150 presents merchant A with the transaction device 150 that preferably includes a smart card, which holds the identifier 152 that associates the transaction device 150 with merchant B (step 220). The merchant terminal 110 reads the identifier 152 from the transaction device 150 using techniques known to those skilled in the art (step 230).

The identifier 152 held on the transaction device is verified against the merchant identification code included in the merchant discount information 160 stored by merchant A or the financial institution (step 240). The verification can include comparing the identifier 152 held on the transaction device 150 with the merchant identification code. Once the information is verified, the financial transaction is consummated and merchant B or employees thereof receive the benefit of the usage scheme (step 250).

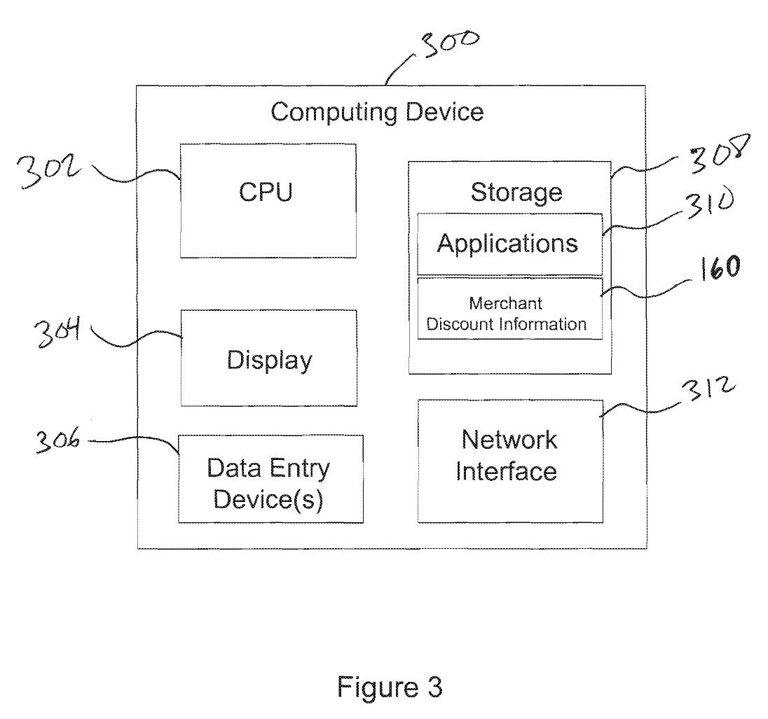

FIG. 3 depicts an exemplary computing device 300 for implementing at least one of the merchant terminals 110a-c or the financial terminals 120 in accordance with the preferred embodiment of the present invention. The computing device 300 can be a mainframe, personal computer (PC), laptop computer, workstation, handheld device, such as a PDA, or the like.

In the illustrated embodiment, the computing device 300 includes a central processing unit (CPU) 302 and preferably a display device 304. The display device 304 enables the computing device 300 to communicate directly with a user through a visual display. The computing device 300 can further include data entry device(s) 306, such as a keyboard, touch screen, infrared sensor, magnetic sensor, bar code reader, and/or mouse.

The computing device 300 can include storage 308 for storing data, such as merchant discount information 160, transaction information, other information as well as instructions, such as instruction for implementing the verification between the merchant identification code and the identifier 152 include with the transaction device 150. The storage 308 can include such technologies as a floppy drive, hard drive, tape drive, Flash drive, optical drive, read only memory (ROM), random access memory (RAM), and the like.

Applications 310, such as an application for performing the process described above in FIG. 2, can be resident in the storage 308. The storage 308 can be local or remote to the computing device 300. The computing device 300 includes a network interface 312 for communicating with networked devices, such as other computing devices. The CPU 302 operates to run the application in storage 308 by performing instructions therein and storing data resulting from the performed instructions, which may be depicted via the display 304 or by other mechanisms known to those skilled in the art, such a print out from a printer.

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed:

1. A method of implementing a merchant specified usage scheme comprising:
obtaining an identifier from a transaction device associating the transaction device with an entity;
verifying at least a portion of the identifier against a merchant identification code; and
determining whether a holder of the transaction device receives a benefit of the merchant specified usage scheme based on the verification.

2. The method of claim 1, wherein obtaining the identifier comprises accessing the identifier from the transaction device using a merchant terminal.

3. The method of claim 1, wherein verifying the identifier against the merchant identification code comprises comparing the identifier to the merchant identification code.

4. The method of claim 1, further comprising providing the holder of the transaction device with the benefit of the merchant specified usage scheme based on the determination.

5. The method of claim 1, further comprising specifying the entity that can participate in the usage scheme.

6. The method of claim 1, wherein verifying the identifier against the merchant identification code further comprises selectively applying the usage scheme based on good or service.

7. The method of claim 1, wherein verifying the identifier against the merchant identification code further comprises limiting availability of the merchant specified usage scheme based on good or service.

8. A computer readable medium comprising instructions executable by a computing device to implement a merchant specified usage scheme that when applied to the device, causes the device to:
verify an identifier associating a transaction device with an entity against a stored merchant discount information; and
determine whether a holder of the transaction device receives a benefit of the merchant specified usage scheme based on the verification.

9. The medium of claim 8, wherein instructions for obtaining the identifier comprise instructions for reading the identifier from the transaction device with a merchant terminal.

10. The medium of claim 8, wherein instructions for verifying the identifier against the merchant identification code comprise instructions for comparing the identifier to the merchant identification code.

11. A system for implementing a merchant specified usage scheme comprising:
a computing device configured to verify an identifier against a stored merchant identification code in response to receiving the identifier and determine whether a benefit of the merchant specified usage scheme is received based on the verification.

12. The system of claim 11, further comprising:
a transaction device that holds the identifier associating the transaction device with an entity, the computing device configured to obtain the identifier from the transaction device and to determine whether a holder of the transaction device receives the benefit of the merchant specified usage scheme.

13. The system of claim 11, further comprising a data entry device configured to read the identifier from the transaction device.

14. The system of claim 11, further comprising a database for holding the stored merchant identification code.

15. The system of claim 11, wherein the computing device is configured to compare the identifier to the merchant identification code.

16. The system of claim 11, wherein the computing device is configured to selectively apply the usage scheme based on a good or service.

17. The system of claim 11, wherein the computing device is configured to limit availability of the merchant specified usage scheme based on a good or service.

18. A transaction device for facilitating a merchant specified usage scheme comprising:
a storage medium that holds an identifier associating the transaction device with an entity, the identifier being accessible by a merchant terminal to determine whether a holder of the transaction device receives a benefit of the merchant specified usage scheme.

19. The transaction device of claim 19, comprising at least one of a credit card, debit card, cell phone or smart card.
